(19) United States
(12) Patent Application Publication
(10) Pub. No.: US 2004/0143650 A1
(43) Pub. Date: Jul. 22, 2004

(54) Method and system for transmission of computer files

(76) Inventor: Michael Wollowitz, Chatham, NY (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/753,382

(22) Filed: Jan. 9, 2004

Related U.S. Application Data
(60) Provisional application No. 60/439,003, filed on Jan. 10, 2003.

(51) Int. Cl. G06F 15/16

(52) U.S. Cl. 709/219

(57) ABSTRACT

A system and method for transmitting and receiving electronic files via a computer network simulates physical postal system functions and images to provide a familiarity that facilitates use by sending and receiving parties. A server functions as the communication link between sending and receiving computers. Accounts for subscribers are established at the server and debited as files are transmitted. A sending subscriber computer displays an image of a physical envelope with data fields for entry of the receiving computer email address at the recipient field, the sending computer email address at the return address field and the amount charged for the transmission at the postage field. A packing list is displayed and permits attachment of files to be transmitted. Upon receiving a package, the server sends a message notifying the recipient that mail is waiting along with a package identification code to be used by the recipient when retrieving the mail. When the mail is retrieved, the receiving computer displays an image of a physical envelope corresponding to that displayed at the sending computer. The receiving computer need not be a subscriber. Subscribers may authorize or send “postage” to non-subscriber correspondents who can then transmit files.

### CROSS-REFERENCE TO RELATED APPLICATIONS

This application claims priority from prior U.S. Provisional Patent Application serial No. 60/439,003, filed Jan. 10, 2003. The entire disclosure in that application is expressly incorporated herein by this reference.

### BACKGROUND

1. Field of the Invention

The present invention relates to the transmission of large computer files between computer users by means of the Internet or other communication channels.

2. Discussion of the Prior Art

Transmission of large computer files over the Internet is an ongoing problem for both business and personal use. Large files are generated by many modern computer applications in areas that include graphics, imaging, design, presentation, and music. Computer users have a common need to transmit or deliver a large file or group of large files to other computer users.

A method for accomplishing the transmission of large files will have the greatest utility if it is easy to use, reliable, inexpensive, flexible, and secure. The method should not require any special skills or training on the part of either the sender or receiver. It should have a very low rate of failure in completing transmissions. It should place a minimal economic burden on users and have the flexibility to support users with a variety of needs and preferences. It should be secure in that the content of the transmitted file is accessible only to the sender and designated receiver. Based on these criteria, existing means for transmitting large computer files are inadequate.

Users may send files as attachments to e-mail transmissions. This has a number of limitations in both functionality and usability. The size of individual attachments is restricted by the mail servers of both the sender and recipient, often having a maximum of about 3 Mbytes. An individual user or company can generally choose to use a mail server that allows for larger attachment files, typically at an increased cost. This is at best a partial solution because the maximum size file that can be transmitted is limited by the mail server with the smaller or smallest attachment size limit; a sender with a large size limit may still not be able to transmit to a receiver whose mail server has a smaller size limit. Further, a sender typically does not know the file size allowed by the recipient's mail server and so cannot know whether a given size attachment will be accepted.

One method typically employed to circumvent the limits on attachment size is to separate the file or files to be transmitted into smaller segments, either manually or by the use of software intended for this purpose. The files are then individually attached to separate e-mails. This is time consuming for the sender and requires that the receiver recombine the individual segments after receiving them.

The total amount of storage allocated on the recipient's mail server, typically referred to as the “mailbox” or “inbox”, is also limited, typically to a range of 3 to 10 Mbytes. This further limits the maximum size attachment that can be transmitted and may interfere with the method of separating a file into smaller segments.

Another method used to circumvent the limits on attachment size, as well as speeding up transmission and reception, is to compress a file or group of files into a single archive such as a “ZIP” or “TAR” type of file. This is effective for certain types of files but does require both the sender and receiver to perform additional operations and to have installed appropriate compression and decompression software.

A further limitation on the use of e-mail attachments to transmit files is that some internet mail services allow only a single file attachment to an e-mail message, thus making it more difficult to transmit groups of files.

A further limitation on the use of e-mail attachments to transmit files is that transmission is generally insecure. Unless the sender encrypts the files (and the recipient has the means to decrypt them), their contents may be read or modified at a series of relay points during the transmission process.

A further limitation on the use of e-mail attachments to transmit files is that errors in receiving attachments are common due to incompatibilities between various e-mail programs and operating systems.

There are several other methods beside e-mail attachments that are used for user-to-user file transmission; each has major limitations.

File Transfer Protocol, or FTP, is another common method for used for transmitting large computer files. To use this method an FTP server program must be operating on a server computer associated with a network to which both the sender and receiver have access. The FTP server maintains a hierarchy of file directories on the server. To transmit a file the sender first copies the file from his or her computer to a directory of the FTP server using a dedicated FTP client program or a version of a web-browser program that supports FTP protocol. The receiver must be informed by some other means, such as e-mail or telephone that the file is available. The receiver then similarly accesses the FTP server and copies the file from the FTP server to his or her computer.

There are many problems with security of file transmission using an FTP-based system. Protection is provided for directories rather than individual file transmissions. Directory access is set be a system administrator rather than the sender of a file. Typically many users have access to the same directory. On many FTP servers users who are not part of the local network cannot be assigned access to protected directories; any directories that they use to send or receive files must be unprotected.

A method that is often used to provide minimal protection is to create a “blind” directory. This is a directory that is unprotected but hidden so that its name does not appear in the directory listing. A user must know its name to be able to access it, thus creating a type of password. In most cases the value of this method is limited, however, because multiple users will be given the directory name and the directory will be used over some extended period.

A further security limitation when using FTP is that passwords, even when they can be used, are transmitted as unencrypted text. If they are intercepted they can immediately be used to access the protected directories.

There are also functional limitations to the use of an FTP-based system for file transmission. The recipient has to be separately notified that a file is available to be received. There is no mechanism to remove from a directory a file that is obsolete or has already been received. There is not reporting mechanism by which a sender can determine whether a file has been received. There is no automatic way to package files in groups to simplify delivery. The only way to add subject text or notes to a file to be delivered is to put an additional file in the same directory and assume that the receiver will take notice of it.

In general, maintenance of an FTP server is too complex and expensive for most users. A system administrator is needed maintain the site. Each additional user must have some understanding of FTP operation and must be provided with passwords and directory information. Depending on the operating systems of their computers, some users may need additional software for FTP access.

A user may also set a web site with dedicated services for file transfer. This requires significantly more effort to set-up and maintain than an FTP site, but simplifies access for other users. This method is also expensive and still requires that notifications, instructions, and passwords be manually delivered to users.

Several commercial web-based systems have been developed for the transmission of large files, one instance being called Whalemail.com. Typically a user sets up an account that allows use of the web-based service. After logging in, the user uploads a file to the web site and enters the e-mail address of the recipient. The service sends a e-mail notification to the recipient that contains a link to the web site and a code number. The recipient accesses the web site and is then allowed to download the sent file using normal web protocol. This is simple process for the sender but has several distinct limitations.

Maintaining an account only allows the user to send files. The account holder cannot receive files unless another user or other users also maintain accounts. Accounts are normally charged on a monthly or annual plan, rather than charging for usage. This becomes expensive if several users must transmit files on an occasional basis.

Typically, only a single file can be uploaded at one time, although the user may be able to individually select multiple files. Selecting an entire directory to upload is generally not possible. While advanced users may be able to add and extract files to a single archive file, this is burdensome for the typical user. No automatic file compression is provided, so the utilization of the connection bandwidth available to the user is not optimized.

In addition, all of the above methods of file transmission put a burden on the recipient to check the incoming files for viruses and to verify that the file originates from a trusted source. The former requires maintaining and using up-to-date anti-virus software, and the later requires the ability to read e-mail headers.

Another common method for transmitting large file is for a sender to copy the file on to computer media, such as a Compact Disk, and then send the media by post or a delivery service to the receiver. The files on the media must then be copied to the receiver's computer. This method of file transmission is time consuming for the sender and the receiver and is always delayed by the time it takes to perform the physical delivery. It also incurs media and delivery costs; the delivery cost may be substantial if rapid delivery is required.

### TERMINOLOGY

For the purposes of this document, all terminology relating to computers, computer software, and computer networks will be defined as generally understood by those skilled in the art at the time of writing. In addition, the following terms are specifically defined for use in this description of the invention:

Network: Any computer network, including intranet, Internet, or similar systems that provides interconnection between computers for functions such as e-mail, web browsing, and file transfer. The preferred embodiments of the invention described herein are intended to operate over the Internet, but the invention is not limited to this type of network.

User: Any person who makes use of a computer for generating, editing, or viewing documents or for accessing a network.

Document: Any computer file that may be generated, edited, or viewed by a user.

Server: Any computer having the primary role of supporting operation of a network or providing services to a network.

Personal Computer (or PC): Any computer, computer terminal, or similar device that has a direct user interface and provides for generation, editing, and viewing of documents. Unless otherwise stated, the PC will be assumed to be connected to a network.

Sender, Sending Computer or First User: A user who acts to send a document via a network to a specific second user or users.

Receiver, Receiving Computer or Second User: A user who receives a document via a network.

File Delivery Service: The implementation of the present invention and, in particular, the server implementation that supports the operation of the present invention.

### SUMMARY OF THE INVENTION

The present invention provides an improved means for sending and receiving files across a network. As a part of this means it applies several novel features that correspond to well understood business methods, previously related to the physical delivery of mail and packages. These features may be used individually or in any combination to make network file transfer easier, more useful, secure, and cost effective, while providing a good business model for the operation of the service.

The basis of one preferred embodiment of the present invention is that the user is presented with an on-screen image of an envelope, mailer, or package. This image, displayed using a network browser or other computer program, is used as an intuitive tool to perform all the necessary functions related to sending and receiving files. Novel features of the present invention are as follows:

The present invention employs a user model and metaphor based on well-known methods previously related to the physical delivery of mail and packages. The intent is that the system will be easy to comprehend and use because it employs terminology and procedures that are familiar to most people. In the following descriptions these familiar terms related to physical mail and package delivery are shown in quotations.

1. Both the sender and receiver of a file transmission may access the service using either a general-purpose web-browser program or a dedicated client program. A server computer, connected to the network, operates with specialized software to create the file transmission service. A part of the underlying functionality of the present invention is that files are uploaded from the sender's computer to the computer server. The receiver is then able to download these files from the computer server to the receiver's computer.

2. A virtual “mailer” or virtual “package” is displayed by the user's browser or client program and provides tools for sending and receiving files. The “virtual mailer” image contains a number of items that correspond to a real mailer, envelope, or package, including a recipients address, a return address, a stamp or other designation of payment, a cancellation or other designation of completion of processing, and miscellaneous optional markings designating additional processes or services.

3. A virtual “postage” payment model may be employed, by which a user can buy “stamps” or “postage” and then use this to transmit files to other users. The transmission of “virtual mailers” may be charged to the user at either a fixed cost or a variable cost that depends on such parameters as the size of the contained files and additional services that the user may select. Unlike real post office stamps, the purchase price of virtual postage may be discounted for various marketing purposes.

4. The “virtual postage” may appear on the computer display as a postage-stamp-like image or a postage-meter-imprint-like image. The purchase may appear to the user as a number of fixed-cost units. For example, a purchase of $5.00 might be displayed graphically or textually as “A book or fifty ten-cent stamps.” Alternately the virtual postage may appear incrementally as stamps or imprints of various values as the individual “virtual mailers” are employed.

5. An extension of the “virtual postage” model and metaphor may be employed by which the user can also “send” stamps to other users so that they in turn can use the stamps to transmit files. Functionally a means is provided by which the first user may create an account for a second user, with a portion of the first user's account balance transferred to this new account. The second user may then use the new account to transmit files.

6. An extension of the “virtual postage” model and metaphor may be employed by which a user who has purchased stamps can send a “postage-paid mailer” that allows second user to transmit a file back to the first user, the cost of transmission being charged to the account of the first user. Functionally, a means is provided by which a first user can create a temporary account for a second user that will allow the second user to transmit one or more files to the first user only, with all charges to be made against the first user's account.

7. An extension of the “virtual postage” model and metaphor may be employed by which a user can create an account and charge the cost for the services to a virtual “postage meter”. The “postage meter” may allow for a variety of payment means that may be more convenient for the user, including a pre-paid account, billable account, or automatic payment (e.g. from a charge card) account. Optionally a number of users, not necessarily at a single location, may be allowed to use the service using sub-accounts, while accruing charges to a single master account. This model is particularly applicable to business use.

8. An extension of the “virtual postage” model and metaphor may be employed by which a first user can create a “receipt requested” transmission that results in an e-mail being sent to the first user verifying that a designated second user has received the transmitted file or files.

9. The basic access to the service is obtained through a standard web-browser program and requires no additional software or hardware on the user's computer. The browser-based service provides for purchasing and distributing postage and sending and receiving files. It employs the above described visual “stamp” and “mailer” or “package” metaphor to make the system easy to use and comprehend.

10. More advanced access to the service is obtained using an optional dedicated client program that resides on the user's computer, either as a stand-alone program or as an add-in program to a web-browser. It provides all of the functionality of the web-browser based access to the service and also allows a sender to easily combine together multiple files or entire directories into a single package to be transmitted in one operation. The package of files may be compressed to shorten transmission time without user intervention being required. The optional program may also provide additional tools such as an address book, “drag and drop” file selection, and improved reporting of transmission status.

11. Similarly, an optional program application, which may be the same application as that described above, adds additional functionality to the process of receiving files. The program separates and de-compresses the files in the received package into individual components to be saved on to receiver's computer.

12. Similarly, an optional program application, which may be the same application as that described above, adds additional functionality to the process of receiving files. The application operates continuously on the receiver's computer and monitors the file transmission service to determine when files are available for to be received. The application may then perform one of several tasks, including: informing the receiver that a virtual “mailer” is available, immediately connecting the receiver to the file transmission service, or automatically receiving the file or files on to the receiver's computer.

13. If the receiver's computer does not or cannot use the optional program application, the file delivery system provides the option of delivering the package as a single compressed file to simplify the reception and reduce the transmission time. The file package is compressed immediately before transmission from the service to the receiver; the receiver is thus able to choose the compression format to match the decompression software already installed on the receiver's computer.

14. The file delivery service may contain means for scanning of all uploaded files for viruses and suspect programs before they are downloaded to the receiver. This means employs available anti-virus programs used in conjunction with the virtual “mailer” features of the service. The receiver may thus see an “imprint” on the virtual “mailer” that certifies that all contained files have been passed by the anti-virus program.

15. Optional means may be employed to provide additional security in conjunction with the virtual “mailer” features of the service. Using public/private encryption technology the sender may be assured that only the intended recipient can obtain the sent files. Further, the receiver can be assured that the files have originated from the expected sender.

16. A specific method may be used for creating a “free trial offer” or other special distributions and awards in which a value of virtual “postage” is given to a user by the service provider at no charge. This provides a simple means for introducing potential users to the service.

17. An optional service that allows a sender to select the appearance of a mailer from a variety of choices.

18. An optional service that allows a user to choose or create an appearance for a mailer and to apply fonts, graphics, or layouts so that the appearance of the mailer is specific to the user or the user's organization.

The aforesaid objects and features are achieved individually and in combination, and it is not intended that the present invention be construed as requiring two or more of the objects to be combined unless expressly required by the claims attached hereto.

The above and still further objects, features and advantages of the present invention will become apparent upon consideration of the following detailed description of a specific embodiment thereof, particularly when taken in conjunction with the accompanying drawings wherein like reference numerals in the various figures are utilized to designate like components.

### BRIEF DESCRIPTION OF THE DRAWINGS

FIGS. 1A, 1B and 1C are schematic illustrations of the computer display images and interface of the present invention by which a user acts to send and receive files.

FIGS. 2A and 2B is a diagram showing the connections and flow of data between a user's computer, network service, and the file delivery service that comprise the supporting mechanism of the present invention.

FIGS. 3A through 3G are flow charts showing the detailed operations that comprise the major processes of the present invention.

### DETAILED DESCRIPTION OF THE INVENTION

Typical operation of the present invention from the perspective of the users is described here. Certain specifics of the user interface to the computer are not described in detail as they may be implemented in a number of ways. The implementation of this interface may include any or all of such typical elements as dialog boxes, menus, icons, directory and file lists, prompts, animations, and sound effects, as well as many others that will be known to one skilled in the art. Further, the order in which tasks are performed may be varied. Examples of a preferred embodiment of the invention are shown in the accompanying illustrations.

The present invention is a computer network-based service, referred to here as a file delivery service. Computer users may open and maintain accounts on this service that will allow these users access to transmit large computer files over the network. The receivers of these large files also access the service but do not need to open accounts to do so.

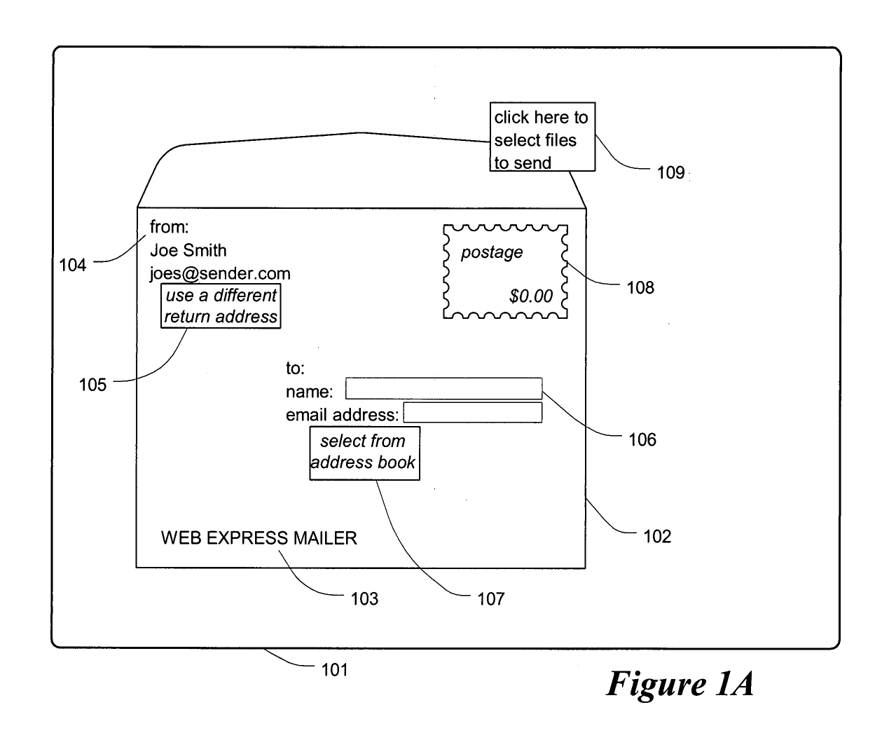

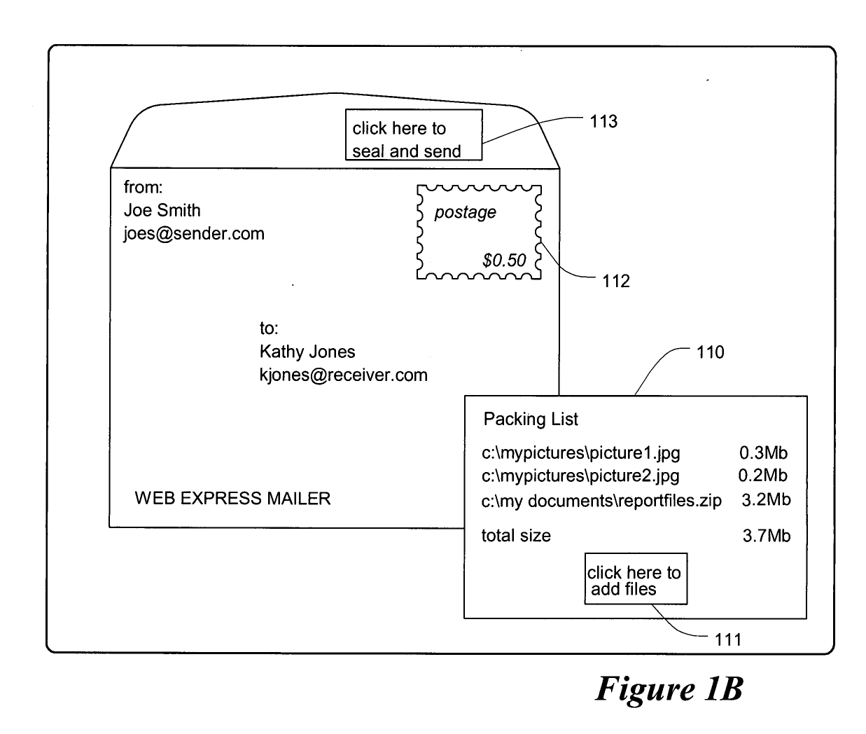

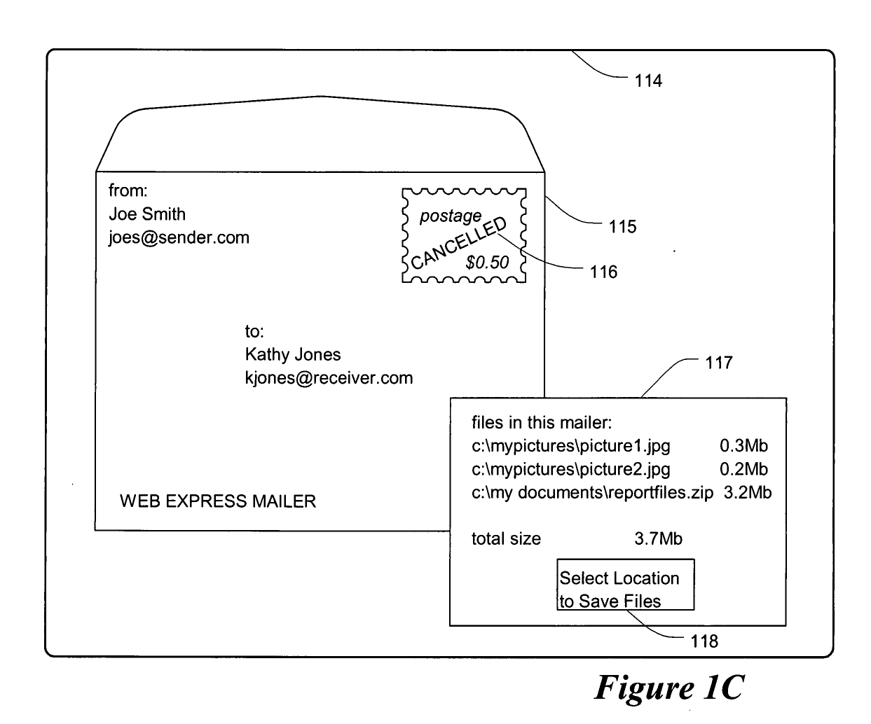

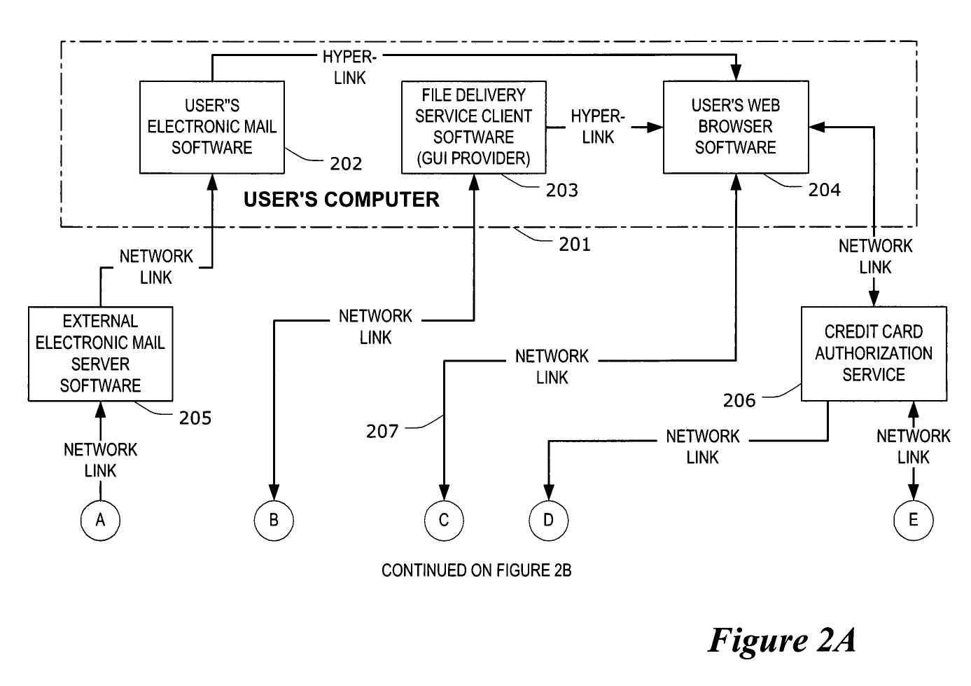

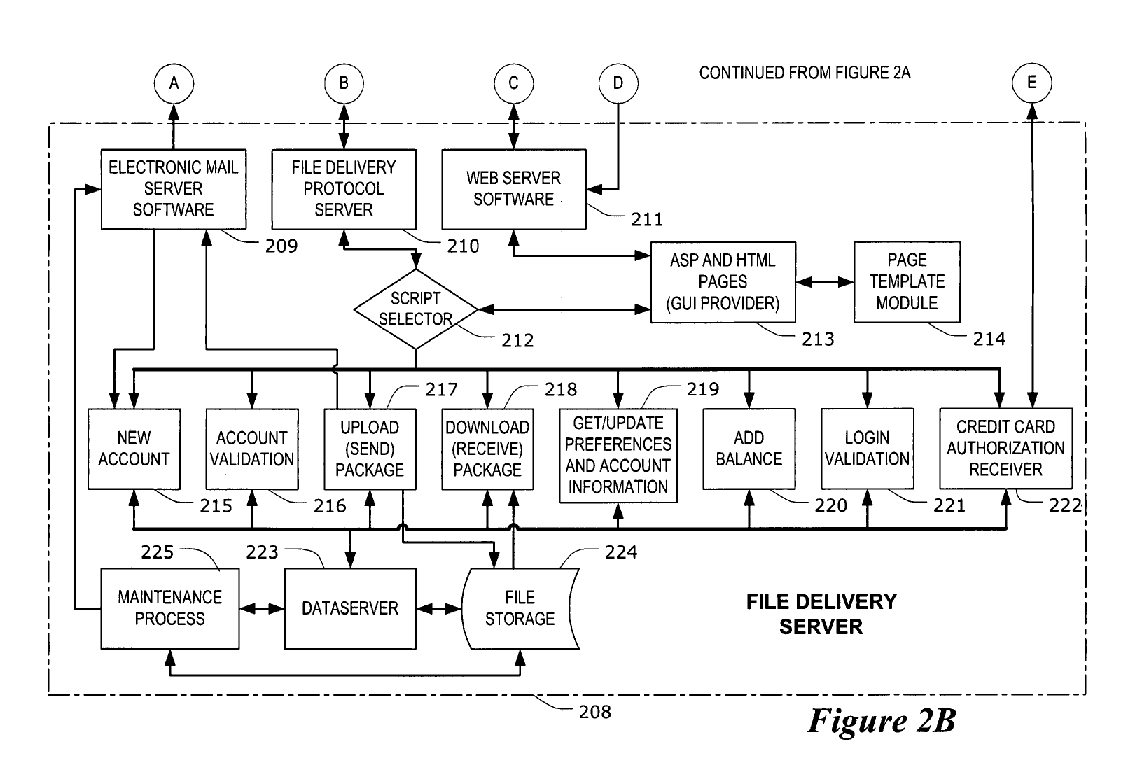

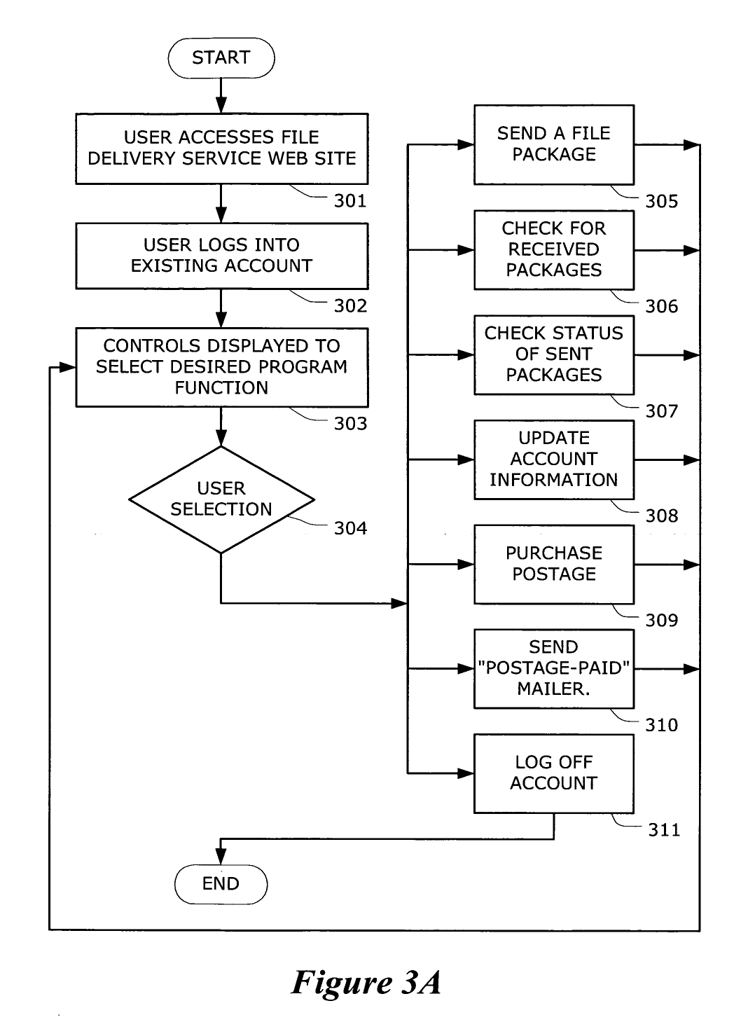

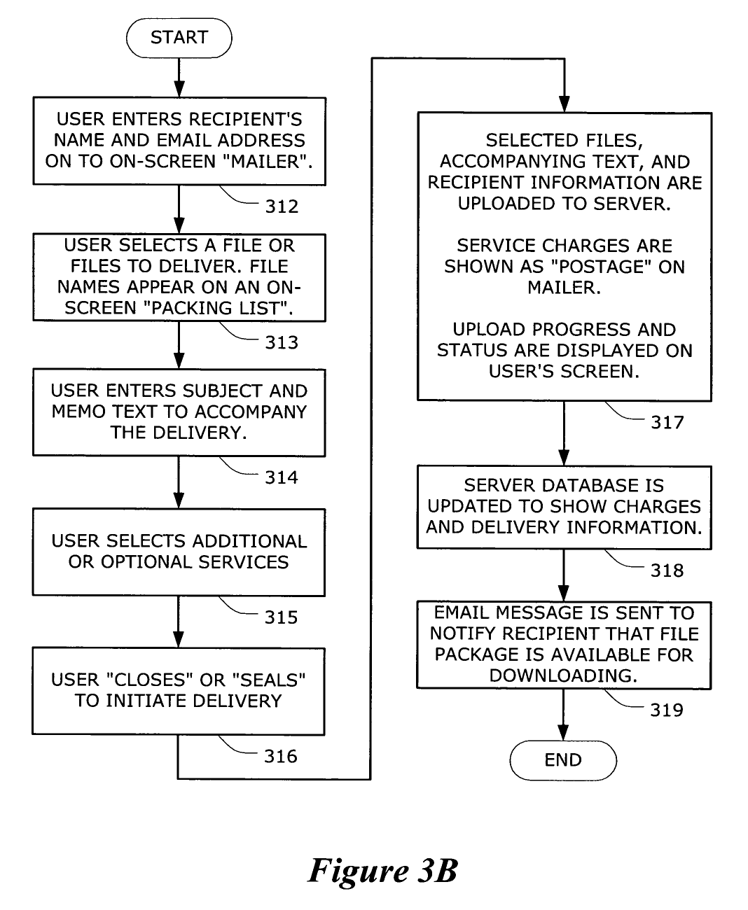

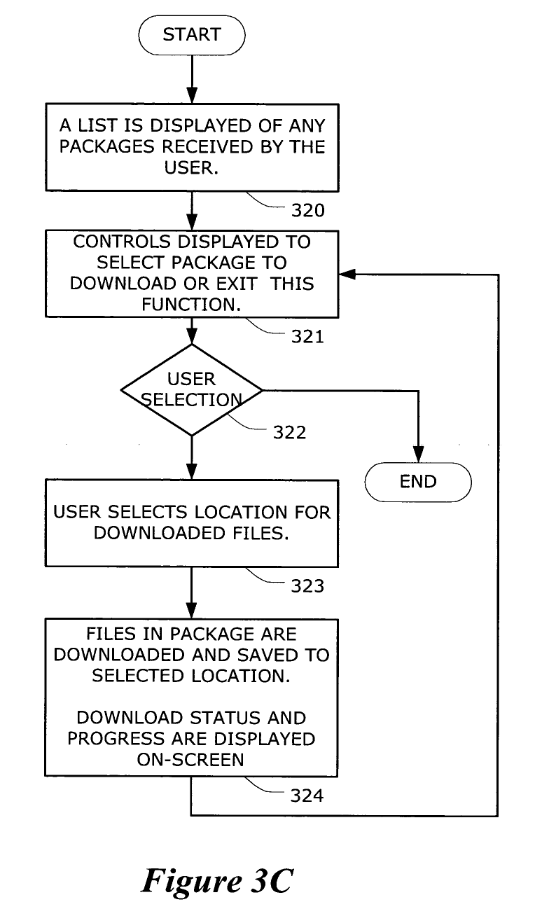

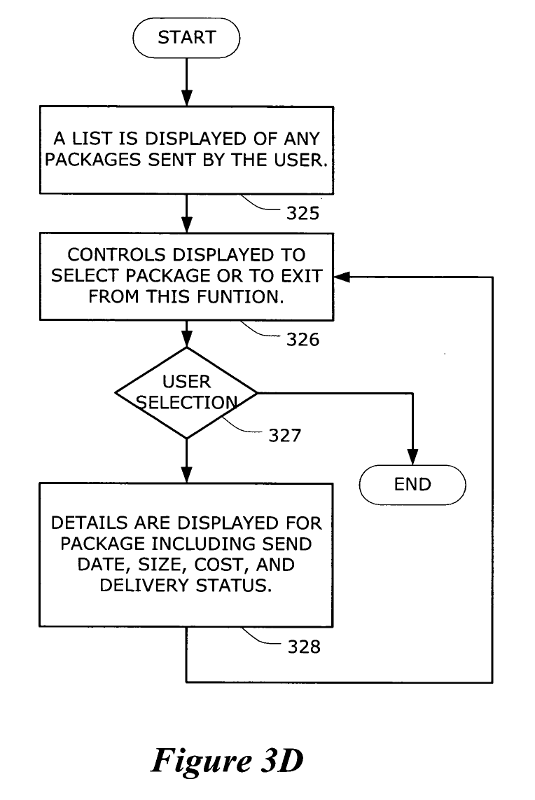

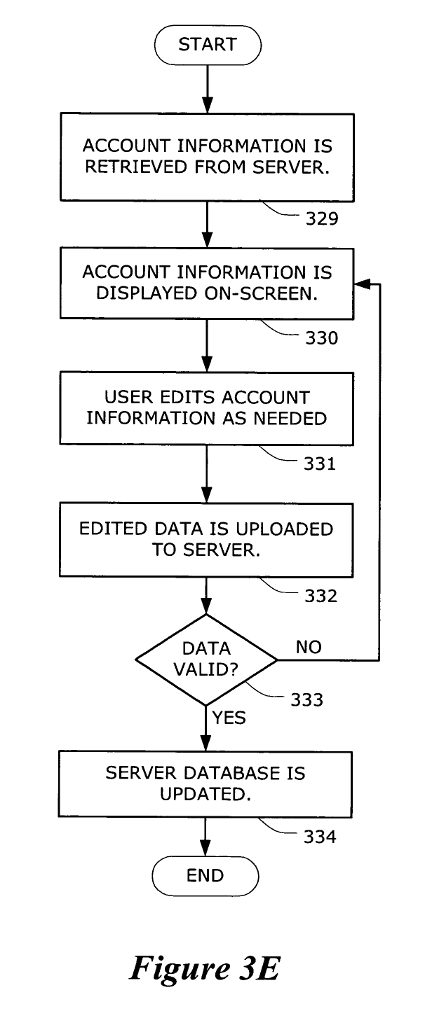

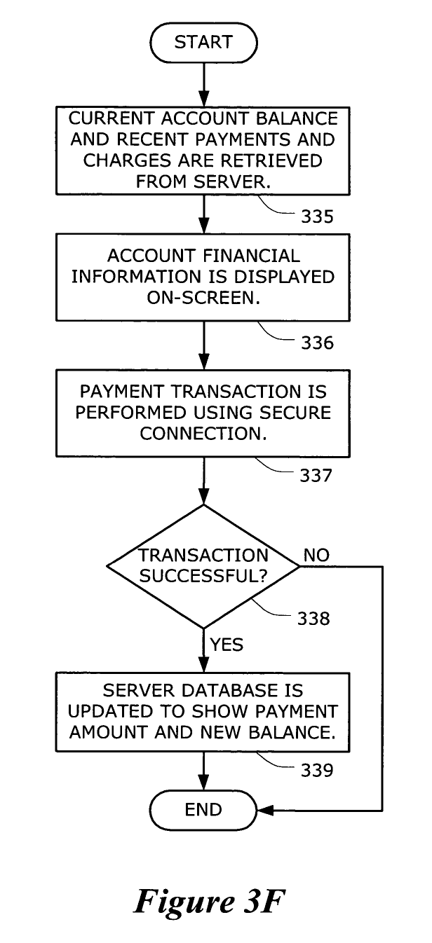

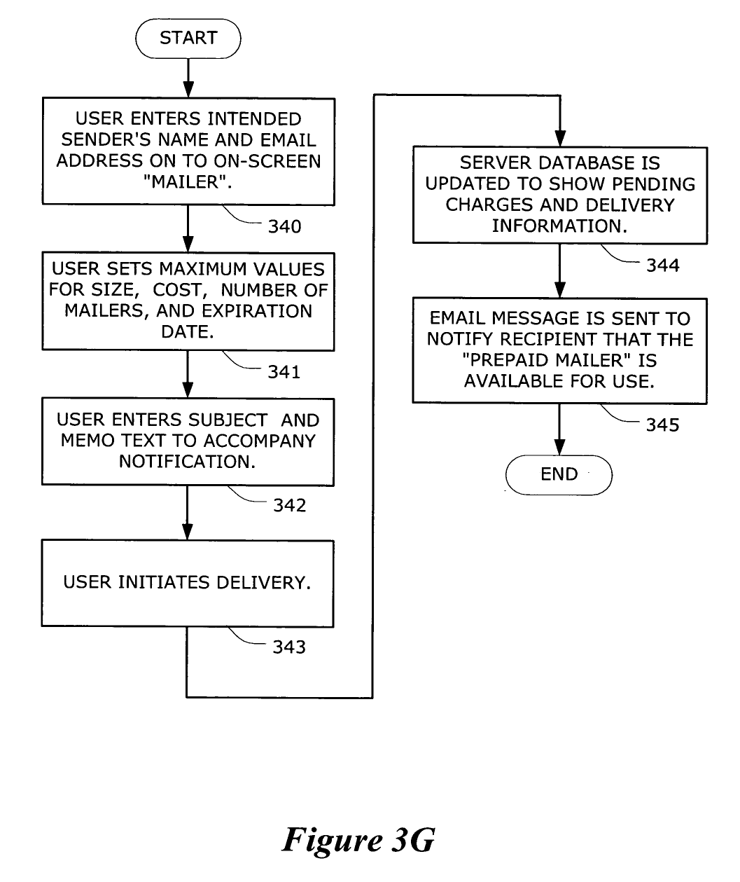

The present invention is first described below in terms of the procedure that a user follows to send and receive files. This is accompanied by FIGS. 1A through 1C that illustrate the most important features of the user interface that supports the process. The invention is next described in terms of the underlying mechanism that supports the process, as illustrated in FIGS. 2A and 2B. Finally, the invention is described in terms of the interactive process between the user and the file delivery service, which is illustrated in FIGS. 3A through 3G.

A computer user accesses the file delivery service using a standard web-browser program or a dedicated client program, either of which operates on the user's local computer. Using a web-browser the user first accesses the service by entering a URL of the main display page of the service in the ordinary manner. Using the dedicated client program the user would typically access the service by starting the client program or, alternatively, starting the client program and then selecting an option to make a network connection. Alternatively, an administrator of the file delivery service may create accounts for a multiplicity of users.

A user intending to use the service to transmit files initially needs to create an account. Responding to on-screen prompts, the user inputs such information as the user's name, and e-mail address. The user either enters a password or the service creates a password and transmits it, typically by e-mail, to the user. As part of the account creation process, the first user may optionally receive an e-mail message from the provider, and then reply to the provider, in order to verify the source of future transmissions. The user then typically makes a payment to purchase a certain value of “postage” to be used for transmitting, or sending, files. The purchase is made using commonly known protocols using a secure Internet connection. Alternative methods for charging for services may be employed in which the user may not be required to make a purchase of “postage”.

At this or a later time, if the user is accessing the service using a web-browser, the user may optionally download a dedicated client program that works in conjunction with the file delivery service.

Alternatively, an administrator of the file delivery service may create accounts for a multiplicity of users. This would be done if a group of users within an organization are to be provided with this service, and particularly if the users will not be individually billed for use of the service.

Once the first user, or sender, has an account the first user can login to the service at any time. The user logs in by accessing the service, as described above and entering a user name, which may be the user's email address, and password.

The first user may then send one or more files to a second user. The user selects an option to send files and is then presented with an on-screen display as illustrated schematically in FIG. 1A. A display window 101 related to the browser or client program contains an illustration of a mailer or package 102, which is shown to be open to accept new contents. The mailer image may include text or graphics 103 that further identify it as package for network delivery. A designation for the sender, typically the sender's name and e-mail address is shown as a return address 104. Blank fields 106 are displayed for the designation of the recipient, typically the name and e-mail address of the recipient. The mailer image also typically includes an image similar to a postage stamp or postage meter imprint 108, which may initially show no charge or a base charge common to all transmissions.

Associated with the image are several means to select actions, typically provided as buttons that can be activated by a mouse click, as well as fields for entering data. The first user enters the name and e-mail address of the intended recipient in the provided fields 106 or, optionally, selects this information from a previously stored “address book” database by using the selection button 107. Optionally, the first user may use another selection button 105 to select or enter different return address information. After completing the above steps, the first user uses a selection button 109 to begin selecting files to be sent.

FIG. 1B illustrates the display during the file selection process. The mailer image continues to be displayed with both the sender and receiver's addresses now shown. Optionally, a means may be provided to edit these addresses. A list of files to be sent 110 is displayed. This list may typically be labeled as a “Packing List” or “Manifest” and be displayed so as to give the general appearance of a printed packing list. An associated button 111 is used to add files to the list; when activated a file-browser window of a common type is displayed and may be used to find and select a file. Other means of selecting files, such as manual typing and “drag and drop” selection may also be provided. Initially no files are shown in the list. In the illustration the first user has already selected three files; the names or file paths and the sizes of the files is typically displayed, along with the total size of the files. Optionally, the packing list display may contain fields in which the first user can add subject and memorandum text that will accompany the transmission.

Typically, as each file is selected, the original postage stamp indication is replaced by an updated indication 112 that shows the charge to send the all files that have been selected. Optionally, the indication of the charges may only be updated when the file selection is complete.

When the first user has selected all the files that are to be sent the first user selects a button 113 to close and send the file package. The service may require a confirmation button to be pressed. The image of the mailer or package may be updated to appear to be closed or sealed. The first user's account typically is checked by the service to determine whether it contains sufficient funds to send the package of files. If not, the user is provided the option of purchasing additional “postage” and to continue with the transmission of the package of files. The files are then uploaded to the file delivery service with no further activity required by the first user. The on-screen display returns to the main selection screen.

After the upload operation is completed the service performs several actions. Its database is updated to reflect the transaction and to record the name and locations of the files, copies of which are now stored at the service location. The first user's account is debited for the charges that were displayed on the mailer. The intended recipient is notified that the file package is available for reception. Typically this is done using an e-mail message; other options for the case in which the receiver has a dedicated client program are discussed later.

The receiver, or second user, receives an e-mail notification that files are available. Typically the e-mail contains a brief description of the function and operation of the file delivery service, the name of the sender, any provided subject text, and a URL link to the service that includes a code number unique to the specific transmission. The e-mail message may also contain a graphical image of the addressed mailer or a simplified iconic image of a mailer; the image may also act as a URL link. The second user may click on the link or cut and paste it to the address line of a web-browser. In either case the web-browser will make a connection to the service and then show an on-screen display as schematically illustrated in FIG. 1C.

The display 114 within the second user's web-browser contains an image of a mailer or package 115 similar to that seen by the first user. The addresses of the sender and receiver are shown and are not editable. The modified image of a stamp or postage meter imprint is shown 116 that includes an overlayed image of the general type of a cancellation imprint. Optionally, the charges may not be shown to the second user.

A packing list image 117 is displayed that is similar to that seen by the first user. It shows the files that are available for reception and, optionally, any subject or memorandum text that accompanies the transmission. Alternatively, the mailer may initially be displayed with the appearance of being closed or sealed and with no packing list visible. The second user then clicks on a marked button to “open” the mailer; this causes the mailer to be redisplayed with the appearance of being open and with the packing list visible.

The packing list has a related button 118 to select the location on the local computer to save the received files; when the second user activates this a directory browser of a common type appears. The second user can then search for and select a directory or create a new directory. Once the second user completes this selection the files are downloaded from the file delivery service to the local computer. An option may be provided by which the service will combine all the files to be received into a single compressed file to simplify and speed up the download process.

The second user may be given the option to first download and install a dedicated client program, which would then simplify and speed up the download of the files. The dedicated client program may then be used for future sending and receiving of files by the second user.

The dedicated client program may act to download the file package as a single compressed file and then to automatically separate it into separate, uncompressed files. It may also act to allow the second user to select multiple locations at which to save the received files, to change the names of the received files, and to use “drag and drop” methods to select the locations for the received files.

If there is a dedicated client program operating on the second user's computer than several additional alternatives are available for notification and downloading. The client program may maintain a continuous or intermittent connection to the file delivery service. In this case the file delivery service can send a notification directly to the client program that a file package is available to be received. The second user may select an option in the client program either to display a notification on-screen that a package is available or to automatically download the file package to a pre-selected directory and then display a notification of this action.

Several additional procedures for transmitting files may be employed using the file delivery service. Alternatively, the first user may access the service, log in, and then select a second user by providing an e-mail address or user name of the second user. The first user may then send selectable amount of previously purchased “postage” to the second user. The second user receives an e-mail message or other notification that states that a new account has been created, and has a balance of the selected amount of postage. If the second user already has an account then the “postage” is added to the balance in that account. The selected amount of “postage” is debited from the first user's account. The second user would then be able to transmit files as described above.

Alternatively, the first user may select a second user and send a “postage paid” mailer. The second user receives an e-mail message similar to that described above, but a limited account is created for the second user that allows one or more transmissions of files only to the first user.

FIGS. 2A and 2B illustrate the underlying mechanism for the process described above. Shown are the user's computer 201, the file delivery server 208, the connecting network, and external services.

The user's computer 201 is the hardware and software—operating system and application programs—that comprise a common personal computer. The software components specifically employed by the present invention includes the electronic mail (e-mail) client software 202, the dedicated file delivery service client 203, and the web-browser 204. These components may be combined in various ways or be functions of other programs without affecting their usage within the present invention.

The user's electronic mail client software is any mail software suitable for communicating with the user's mail server. The user can receive several types of e-mail notifications from the file delivery service. These mail notifications contain hyperlinks to the file delivery service, and the hyperlinks also contain the information necessary to identify the notification and user to the service. This e-mail client and service is used to validate e-mail addresses for new accounts and to notify users of file packages that are available to be received.

The file delivery service can communicate with the user's computer in one of two modes—either using web access, or using specialized dedicated client software. When the user is running the client software, it is this software that handles the entire user interface experience, with the file delivery server providing the file storage, database, and delivery capabilities. The client software can launch the user's browser for certain options such as payment processing, but communicates with the file delivery server using a proprietary protocol. This protocol may optionally be encapsulated within a standard internet protocol such as HTTP.

The user's web browser is used to access the file delivery service when the client software is not present. It is also used also to process validation e-mails and may provide a secure communication means for initiating credit card transactions.

The network is the set of links 207 between the users' computers and various services including the file delivery server and comprises any means of communication between a multiplicity of computers or devices that contain computers. The network may be the Internet, as accessed through the user's Internet Service Provider (ISP), a Local Area Network, a Wide Area Network, or, more generally, any combination of networks of these or any other type.

FIGS. 2A and 2B represent the interaction between a single computer user and the file delivery server. A useful system will include a multiplicity of users' computers, all connected through a complex of networks to the file delivery server, although not necessarily connected at the same time.

The file delivery server 208 comprises the hardware and software components that provide the file delivery service. The components are generally software processes that may operate on a single or on multiple computers.

The electronic mail server software 209 is used to send account verification and package notification e-mail messages. This may be any mail server software, but currently would typically be an SMTP mail server such as the Microsoft SMTP Server included with IIS.

The protocol server 210 handles communications from the file delivery system's client software and passes these requests through to the script selector module. The purpose of this module is simply to provide a communications interface with the client software.

The web server software 211 may be of any common type, with Microsoft Internet Information Service or Apache being among currently available options. This communicates with the user's browser, taking content from HTML pages, ASP (Active server Scripts) scripts, or other communication protocols on the server.

The script selector module 212 processes the requests from the GUI on the user's computer, which is either implemented in ASP scripts and HTML pages on the server or is implemented in the dedicated client software. The appropriate script is then called to handle the request.

ASP and HTML files on the web server 213 provide the GUI interface when the user accesses the service via the web interface.

The page template module 214 consists of scripts, HTML pages, and include-files that are used by the main ASP and HTML files on the site to provide a consistent look and feel throughout the site.

The new account module 215 handles the creation of a new account, using the data server 223 to store the new account data, and using the electronic mail server 209 to send validation e-mail to ensure that the e-mail address the user entered is valid. The account is not considered active until the user clicks the link in the e-mail message and the account validation module 216 is run.

The account validation module 216 receives parameters from the hyperlink in the e-mail sent by the new account module 215, and based on these parameters determines the whether the account may be validated. Typically, one of these parameters is a “safety number”, a random number generated by the new account module. This safety number is both stored in the database by the data server 223 and included in the hyperlink. Both numbers must match in order for the account validation module to activate the account. The data server 223 is then used to modify the database to mark the account as active.

The upload module 217 handles the upload (sending) of a package. The actual data transfer is handled by the web server 211 using scripts for the web interface provided by the page template module 214, or by the file delivery protocol server 210 when file delivery client software is being employed. This module simply accepts the uploaded data, stores it on the file storage 224, and makes the appropriate entry in the database using the data server 223 to record the presence of the package and debit the user's account. The file is stored before the database entry is made in order to preserve database integrity; otherwise if an error occurs during the file storage process, the database record would exist without an associated file. This creates the possibility of orphaned files—that is, files that have been stored with no associated database entry. These are removed by the maintenance process 225.

The download module 218 handles the downloading (receipt) of a package. The data server 223 is consulted to determine the actual storage name and location of the file, and the appropriate file is then retrieved from the file storage 224 and passed back to the web server software 211 or file delivery protocol server 210 for delivery to the user.

The module to get or update preferences and account information 219 responds to requests to retrieve or update the account information. This is used by the ASP and HTML pages 213 and the file delivery client software 203 to perform many tasks, including changing the e-mail address and/or password associated with the account, getting account information, balance and transaction history, and so on. This module uses the data server 223 to retrieve or change the appropriate records in the database.

The add balance module 220 uses the data server 223 to make the appropriate entry in the database to indicate that a transaction has been started to add a balance to the user's account. The balance is not actually credited to the account, however, until the credit card authorization receiver module 222 receives notification from the credit card authorization service 206 of the success of the transaction.

The login validation module 221 takes a user name and password, as supplied via a secure network connection, and validates them against the database to ensure that they are valid. Passwords are stored in the database using one-way encryption to ensure that they can be validated but not decrypted.

The credit card authorization receiver module 222 receives credit card authorization notifications from the credit card authorization service 206, validates them with the credit card authorization service to ensure they are not forged, and makes the appropriate modifications to the database. This module is used only for accounts that employ credit card billing.

The dataserver 223 can be any data server software, but should be software that supports transaction integrity. Current software of this type includes Progress, Oracle or InnoDB on MySQL.

The maintenance process 225 runs periodically and performs several important tasks, including scanning for orphaned files left behind by incomplete (backed out) database transactions in the upload module 217, as well as checking for packages that have been available for delivery for too long and sending reminders or expiring packages when necessary.

The file storage module 224 may be any type of computer data storage that allows repeated storage and retrieval of a multiplicity of large files. Currently it typically consists of standard hard drive storage space on the file delivery server. The database files used by the data server 223 are stored here, as well as the files that make up any packages that are out for delivery.

An external electronic mail server 205 may exist on the user's ISP or local network and relays e-mail messages from the file delivery service to the user's e-mail client software 202. An external credit card authorization service 206 is employed when needed to validate credit card transactions and authorize payments.

FIGS. 3A through 3G illustrate the major functions of the file delivery service and typical interactions between the user and the service. In the related descriptions it is assumed that the user is accessing the service using a standard web-browser program and network connection. The program operating on the server computer transmits data via the network to the user's computer to control the display within the web-browser. The user responds to the prompts and tools that are displayed and enters information using a keyboard, computer mouse, or other related device. The user's responses are transmitted back to the server, which performs certain appropriate operations and transmits additional data to update the display within the web-browser. At a certain point in this sequence a file or group of files is either uploaded from the user's computer to the server or downloaded from the server to the user's computer. Thus the present invention comprises a process of interaction between the user and the file delivery service via the web-browser and network. The present invention further comprises a mechanism, instantiated in software on the server computer, to support this process.

FIG. 3A illustrates the overall interaction between the user and the file delivery service. The user first accesses the service website 301. The service displays prompts and entry fields for user login. The user then enters the requested login information 302, typically a user name and password. Alternately the user may be logged in automatically if this is supported by the software operating on the user's computer.

The service validates the login information. If the login is accepted, the service responds by displaying prompts and selection controls to allow the user to select from among the functions of the service 303. The user then selects a function 304, typically by clicking on an on-screen button. The service responds by displaying prompts and controls appropriate to the selected function.

The functions that may be selected include sending a package of files 305, checking for received packages 306, checking the status of sent packages 307, updating account information 308, purchasing postage 309, or sending a “postage paid” mailer 310. The functions are shown in more detail in FIGS. 3B through 3F. Upon completion of any of these functions, the service re-displays the selection of available functions 303. The user may also choose to log off 311; the service responds by logging off the user and displaying a different page or closing the browser window. Other service functions may be added without compromising the fundamental functionality of the service.

FIG. 3B illustrates the interaction that occurs when the user chooses to send a package of files. The service displays a mailer image with a field on which a recipient's name and e-mail address may be entered. The user fills in the required fields 312. Options may be provided to enter addresses for multiple recipients or to select recipients from a list or an address book. The user then opts, typically by a button click, to select files. The service responds by displaying an empty “packing list” and tools for the selection of files. The user selects the files to send and the service responds by displaying the files names on the “packing list” 313. The user also enters subject and memorandum text into appropriate fields on the “packing list” 314. Alternately, the service may display an editing window for text entry.

The service may display choices for additional or optional services. The user may select from among these service 315, in which case additional prompts and controls may be displayed and the user may be required to enter additional information. The user then “closes” or “seals” the package of files to initiate delivery 316, typically be clicking on a button. The service may request a confirmation by the user before continuing.

The service then uploads the selected files to the file delivery server and displays additional information on the user's computer 317. The charges for the service are displayed, typically as “postage” on the on-screen mailer and the progress and status of the upload are displayed. Charges may be calculated various bases including a fixed fee, a charge based on the package size, or a combination or the two

Upon completion of the file upload the server database is updated to show the charges, delivery information, location of stored files on the server, and other appropriate data 318. An e-mail message or other notification is then sent to the recipient or recipients 319, providing the information that the file package is available for downloading or reception.

FIG. 3C illustrates the interaction that occurs when the user chooses to check for received packages. The service displays a list showing packages that have been received by the user 320. This list may only show packages that have not previously downloaded, or it may display all received packages and indicate those that have not yet been downloaded. The service also displays prompts and displays to select downloading of specific packages or to exit from this function 321. The user then selects the package or packages to be downloaded or selects to exit from the function 322. Alternately, the service may provide the user with the option of selecting individual files from one or more packages for downloading.

The service displays controls to allow the choice one or more locations on the user's computer to save the downloaded files. The user then selects the location or locations to use 323. The files are the downloaded from the file delivery server to the user's computer and saved to the selected locations. The service displays the status and progress of the download on the user's computer 324. At the completion of the download, the service redisplays the list of available packages and the controls for selecting packages for downloading 321.

When a receiver has received an e-mail notification that a package or files is available, the receiver may use a simplified method for downloading the package. The e-mail message contains a link to the file delivery service that includes a core number specific to the particular file package and receiver. By clicking on the link the receiver acts to open the browser program on the receiver's computer and access the file delivery service. Alternately, the receiver may enter the link text into the browser to access the service. The service accepts the code number and extracts the corresponding package information from its database. The service then displays a mailer image that shows the sender and receiver addresses and the subject and memorandum text created by the sender. A listing of the contents of the package may also be displayed, along with instructions for downloading the files. In the manner described above, the receiver then selects a location to save the files and the files are downloaded to the receiver's computer. This method for receiving files allows a receiver to easily download a file package even if the receiver does not have an account on the service or is unfamiliar with it.

FIG. 3D illustrates the interaction that occurs when the user chooses to check the status of sent packages. The service displays a list of packages that have been sent by the user 325. The service may indicate which of these packages have been received. The service displays controls to select a package from the list or to exit from this function 326. The user then selects the package or packages to be downloaded or selects to exit from the function 327. The service responds by displaying information about the selected package including the date sent, size, cost, and delivery status 328.

FIG. 3E illustrates the interaction that occurs when the user chooses to update account information. The account information is first retrieved from the file delivery server 329. The service then displays this information of the user's computer screen 330. Information that may be edited is displayed in editable fields. The user then edits or updates the account information as required 331. This may include changes to personal information, selection of new passwords, or changes in user preferences. The service responds by uploading the edited information to the file delivery server 332 and checking it for validity according to predetermined criteria 333. If the information is determined to be invalid the service redisplays s screen to allow the user to re-edit the information. Prompts may be displayed to inform the user why the information is considered invalid. If the information is successfully validated, the database of the file delivery server is updated to reflect the changes 334.

FIG. 3F illustrates the interaction that occurs when the user chooses to purchase postage. The service retrieves the user's account information from the file delivery server including the current balance and recent payments and charges 335. The service then displays this information on the user's computer 336. A payment transaction is then conducted using common, secure transaction means, typically employing a dedicated credit card payment service 337. The transaction means reports the result of the transaction to the file delivery service 338. If the transaction is successfully completed the file delivery server database is updated to show the show the payment amount and the new account balance 339.

FIG. 3G illustrates the interaction that occurs when the user chooses to send a “postage paid” mailer. A mailer image is displayed by the service. In this case the recipient address shown on the mailer is typically initially set as the address of the first user, the user currently active. The “return address” fields are initially blank. In these fields, the first user enters the address information, typically the name and e-mail address, of a second user who is to receive and use the “postage paid” mailer 340. As described previously, an address list or address book may be employed to fill in the fields. The first user may also be allowed to change the recipient address fields to be directed to a different e-mail address or a third user.

The service displays prompts and tools to allow the first user to set certain limits on the use of the “prepaid mailer”. The user may set values for some combination of the maximum allowable package size, the maximum allowable cost, the total number of “prepaid mailers” to be delivered, and the expiration date for the use of the mailer or mailers 341. The user may also fill in fields for subject and memorandum text to accompany the notification e-mail 342. The service accepts the various data input by the user and responds by calculating and displaying the projected cost for the service. Charges may be calculated various bases including a fixed fee, a charge based on the package size, or a combination or the two. The user then initiates delivery 343, typically by clicking an on-screen button.

The service then updates the file delivery server database to show pending or incurred charges and delivery information 344. An e-mail notification is then sent to the second user that the “prepaid mailer” is available for use 345. The e-mail message contains a link to the file delivery service, a code number for the particular transaction, and an explanation and instructions for the service.

The second user, upon opening the e-mail message, can click on the link or copy it into a web-browser to access the file delivery service. The service displays an addressed mailer image. The return address is that of the second user; the sending address is that of the first user or, optionally, a designated third user. The second user may add files to the mailer and send it, in the manner previously described. The service acts to upload the files from the second user's computer and to notify the intended recipient, who is the first or third user. The charges for transmitting the file from the second user to the first or third user are billed to the first user. Using the “prepaid mailer” method allows a first user, who has an account with the file delivery service, to work with a second user and to provide the second user to transmit large files to the first user or a third user.

For the processes described above, the user may also interact with the file delivery service using a dedicated client program The program may independently provide network connection services or it may add functionality to a standard web browser program. In this case certain operations may take place on the user's computer rather than on the file delivery server. Such information as address books and user preferences may be stored on the local computer. Selection of files for transmission and other similar operations may be handled locally without intervention from the file delivery server. In this case the file delivery service may be considered as the combination of the file delivery server and the local client program operating together. The interactions between the user and the service remain closely equivalent to those described above.

Additional functionality may be added to the above-described processes. Certain additional functionality requires the use of a dedicated client program while other functionality may operate using the primary web-browser based service.

A dedicated client program may have the functionality to compress files to be uploaded from a sender's computer to the file delivery server so as to reduce the upload transmission time. The compression may take place automatically and without intervention by the sender. The sender can achieve the same increase in transmission speed as by using a separate compression program but without the additional complication and effort of doing so. The compression format used may be a common one such as the ZIP or TAR type or it may be a special compression format chosen for efficiency, security, or maintenance of a proprietary standard. The files may be stored on the file delivery server in the compressed format or they may be decompressed to allow for additional operations.

A dedicated client program may have the functionality to decompress files as or after they are downloaded from the file delivery server to a receiver's computer so as to reduce the download transmission time. The decompression may be automatic and may use a common or special compression format. The file delivery server may transmit files that are already compressed or it may compress the before or during transmission. This allows the receiver to obtain the increased transmission speed due to compression even if the sender has not compressed the file or has compressed them in a format that is not compatible with the receiver's computer.

In the case where the receiver is using the basic web-browser interface to the service automatic decompression on the user's computer is typically not possible. The receiver may be provided with two options to reduce the download transmission time. First, if the package of files is not already compressed in a common format, the receiver may select to have the service compress the package into a single compressed file in a common format before or during download transmission. Second, the receiver may select to first download and install a client program that will then handle the download of the file package and can supply decompression as described above.

A dedicated client program may have the functionality to automatically make a connection the file delivery server, either continuously or at regular intervals, and to determine whether any file packages are available for reception by the user. The program may then either notify the user of the package's availability or automatically initiate the download of the package to the user's computer and, optionally, notify the user that the package has been downloaded.

The file delivery server may optionally inspect all uploaded packages of files for the presence of computer viruses or other suspect file types. If the contained files all pass the inspection then the mailer image seen by the receiver may show an imprint image certifying that the inspection has been passed.

The file delivery service may optionally provide an additional service whereby uploaded packages of files are copied on to standard computer data media and the media is then physically delivered to the recipient. This provides a convenient means of delivery to a receiver who may not be able to download a large file or package of files. This optional service may be initiated either by the sender or receiver. If initiated by the sender the additional service appears as an option during the sending process and the related charges are typically billed to the sender. If initiated by the receiver the additional service appears as an option during the download process and the related charges are typically billed to the receiver.

The file delivery service may optionally provide additional services for the physical delivery of other media in a manner similar to that described for computer data media. This may include the printing of document file, the printing of digital images, and the copying of audio or video files on to appropriate presentation media. Initiation of these services and the charges related to them may be handled in a manner as described above for the use of computer data media.

The file delivery service may optionally provide additional services for the translation of document files between different formats to reduce file sizes or allow use of the files on computers having different operating systems or application programs. Document files may also be converted to a common facsimile format and the service may then have the option to deliver documents using the common facsimile, or fax, protocol.

The file delivery service may optionally provide additional services for the transmission or distribution of file packages to groups of receivers. As an equivalent to the concept of bulk mail, the service may provide discounted rates for delivery of a common file package to multiple recipients. The service will send a common or personalized e-mail notification to all intended recipients and the sender will be able to determine which intended recipients have downloaded the file package.

The file delivery service may optionally provide the additional service of delivering a confirmation e-mail message to the sender of a file package immediately after the receiver has completed downloading of the package. The receiver may further be required to enter an identifier, typically the receiver's name and e-mail address, prior to downloading or opening the file package. This provides an equivalent of “receipt requested” mail.

The file delivery service may provide the option that the headers of notification e-mail messages show the e-mail address of the sender rather than of the service as the sender. This will cause the senders e-mail address to appear as the sender in the display on the receiver's e-mail client program. It may further prevent the notification e-mail from being blocked by the user's firewall. Alternately, the service may provide the user with the option of generating the notification e-mail on the user's computer and sending it through the user's e-mail server.

All of the options and additional services described above may be combined in any practical manner. In particular, those options and services that are specific to the use of a dedicated client program may be combined in any way with options and services that are independent of the means by which the user accesses the service.

Having described preferred embodiments of a new and improved method and system for transmitting electronic files, it is believed that other modifications, variations and changes will be suggested to those skilled in the art in view of the teachings set forth herein. It is therefore to be understood that all such variations, modifications, and changes are believed to fall within the scope of the present invention as defined by the appended claims.

What is claimed is:

1. A method for sending and receiving electronic files via a computer network comprising the steps of:
(a) establishing a connection on said network between a sending computer and a server programmed to provide file transmission service;
(b) at said sending computer:
(b.1) displaying a simulated postal envelope, mailer, or similar packaging of a type commonly used for the delivery of printed documents with designated data fields permitting entry of a return address of said sending computer and a receiving address of a receiving computer at respective locations on said envelope;
(b.2) providing means for selecting, from electronic files that are stored at said sending computer, files to be sent to said receiving computer;
(b.3) displaying a simulated packing list of files selected in step b.2;
(b.4) providing means for effecting transmission via said network of a package comprising said return and receiving addresses and the selected files to said server;
(c) at said server, in response to receiving said package, transmitting a notification via said network to the receiving computer at said receiving address that said package is available for reception;
(d) at said receiving computer, selectively retrieving said package via said network from said server.

2. The method of claim 1 further comprising the step of:
(e) establishing an account for said sending computer at said server, said account containing a balance of funds to be charged to said sending computer for packages transmitted by said sending computer via said server, and enabling said sending computer to selectively deposit funds in said account;
wherein step (b) further comprises the step of:
(b.3.1) displaying at said simulated envelope charges to be assessed against said account for the transmission of said package to said receiving computer;
and wherein step (c) further comprises the steps of:
(c.1) in response to receiving said package, prior to sending said notification to said receiving computer, determining whether or not said account of said sending computer contains sufficient funds to cover the charges of transmitting said package;
(c.2) in response to a determination in step (c.1) that said account contains sufficient funds, uploading said package and debiting said account of said sending computer by an amount corresponding to the charge for transmitting said package, and transmitting said notification to said receiving computer;
(c.3) in response to a determination in step (c.1) that said account contains insufficient funds, notifying said sending computer that there are insufficient funds in said account.

3. The method of claim 2 wherein step (b) further comprises the steps of:
(b.3.2) displaying, along with the charges for transmitting said package, the amount of funds currently in said account; and
(b.3.3) indicating if the charges for transmitting said package exceed the amount in said account and, if so, providing means for adding funds to said account.

4. The method of claim of claim 1 wherein said notification to said receiving computer comprises an email description of the contents of said package and a code number unique to said package,
wherein step (d) comprises the steps of:
(d.1) establishing a connection between said receiving computer and said server;
(d.2) in response to establishing the connection in step (d.1), transmitting said code number to said server;
and further comprising at said server, the steps of:
(e.1) in response to receiving the code number in step (d.2), transmitting to the receiving computer an image of a simulated postal envelope or other packaging similar to the envelope displayed at the sending computer with said return address and said receiving address;
(e.2) enabling the receiving computer to effect transmission of at least some of said package from said server to said receiving computer.

5. The method of claim 4 wherein:
step (e.1) includes transmitting to the receiving computer, along with said image, a list of the files included in the package received by the server in step (c); and
step (e.2) includes enabling the receiving computer to selectively effect transmission thereto from the server of individual files appearing in the list transmitted in step (e.1).

6. The method of claim 4, prior to step (e.1), further comprising the step of providing the receiving computer the option of downloading from the server and installing a dedicated client program to simplify and accelerate downloading of the files in the package.

7. The method of claim 1 wherein:
step (b.1) further comprises the step of providing means for entering a message to be transmitted with said package; and
step (b.4) comprises providing means for transmitting said message along with said package.

8. The method of claim 1 further comprising the steps of:
(e) establishing an account for said sending computer at said server, said account containing a balance of finds to be charged to said sending computer for packages transmitted by said sending computer via said server, and enabling said sending computer to selectively deposit funds in said account;
at said sending computer, sending a predetermined amount of funds authorization for transmitting files via said server by a third computer by means of the steps of:
(b.5) identifying said third computer and said predetermined amount of funds to said server;
at said server:
(c.1) determining whether or not the third computer has an account at said server;
(c.2) in response to a determination in step (c.1) that an account exists, crediting said account with the predetermined amount of funds and transmitting notification of said crediting to said third computer; and
(c.3) in response to a determination in step (c.1) that an account does not exist, creating a new account for the third computer, crediting said new account with the predetermined amount of funds, and transmitting notification of said new account and crediting thereof to said third computer.

9. The method of claim 1 further comprising the steps of:
(e) establishing an account for said sending computer at said server, said account containing a balance of funds to be charged to said sending computer for packages transmitted by said sending computer via said server, and enabling said sending computer to selectively deposit funds in said account;
at said sending computer, sending a predetermined amount of funds authorization for transmitting files via said server by a third computer by means of the steps of:
(b.5) identifying to said server said third computer and said predetermined amount of funds, and indicating to said server the said predetermined amount is to be charged to the account of said sending computer;
at said server:
(c.1) transmitting notification to said third computer that said sending computer has authorized pre-payment in said predetermined amount for transmission of files by said third computer via said server; and
(c.2) enabling said third computer to transmit files via said server.

10. The method of claim 1 further comprising the step of:
(e) establishing an account for said sending computer at said server, said account containing a balance of funds to be charged to said sending computer for packages transmitted by said sending computer via said server, and enabling said sending computer to selectively deposit funds in said account;
wherein step (b) further comprises the step of:
(b.3.1) displaying at said simulated envelope actual charges to be assessed against said account for the transmission of said package to said receiving computer.

11. The method of claim 10 wherein step (b.3.1) comprises transmission from the server to the sending computer said actual charges, and wherein said actual charges may be either a fixed cost per transmission or dependent upon one or more parameters of said package.

12. The method of claim 10 wherein step (b.3.1) comprises displaying said actual charges at said simulated envelope as a simulated postage stamp or simulated postage meter imprint.

13. The method of claim 10 further comprising the step of displaying a virtual postage meter at said sending computer to store and display the balance in said account.

14. The method of claim 10 wherein:
step (b.4) includes the step of:
(b.4.1) providing means for indicating to the server that a confirmation of delivery of the package to the receiving computer is requested; and
step (c) includes the step of:
(c.1) in response to receipt of a request in step (b.4.1) and to successful transmission of the notification in step (c), transmitting to the sending computer a notice of confirmation of delivery.

15. The method of claim 1 further comprising the step of:
(e) establishing an account for said sending computer at said server, said account containing a balance of funds to be charged to said sending computer for packages transmitted by said sending computer via said server, and enabling said sending computer to selectively deposit funds in said account;
wherein step (b) further comprises the steps of, at the sending computer:
(b.5) displaying a pre-paid mailer for use by the receiving computer to transmit one or more files to the sending computer, said pre-paid mailer having data fields for entering the address of the sending computer as recipient and the address of the receiving computer as sender; and
(b.6) transmitting the pre-paid mailer to the server for transmission to the receiving computer;
wherein step (c) further comprises the steps of, at server:
(c.1) transmitting the pre-paid mailer to the receiving computer; and
(c.2) enabling transmission of the pre-paid mailer with one or more attached files from the receiving computer to the sending computer via said server.

16. The method of claim 1 wherein access to the server by the sending and receiving computers is provided by a web-browser program using the internet or similar global computer communications network.

17. The method of claim 1 wherein access to the server by the sending computer is provided by a dedicated program using a computer communications network.

18. The method of claim 1 further comprising the step of:
(d.1) at the receiving computer, continuously monitoring the network to determine if and when files transmitted to the receiving computer are available to be received.

19. The method of claim 18 wherein step (d.1) includes automatically receiving the files available to be received.

20. The method of claim 1 wherein step (c) comprises, at said server:
(c.1) scanning all received files for viruses and suspect programs prior to transmission to the receiving computer; and
(c.2) notifying the receiving computer that all files transmitted thereto have been scanned per step (c.1).

21. The method of claim 1 further comprising the steps of:
encrypting files selected in step (b.2) at the sending computer prior to transmission to the server;
re-encrypting files received by said server prior to transmission of the received files to the receiving computer; and
at the receiving computer, de-encrypting files received from the server.

22. A method for sending and receiving electronic files via a computer network comprising the steps of:
(a) establishing a connection on said network between a sending computer and a server programmed to provide file transmission service;
(b) at said sending computer:
(b.1) displaying a simulated postal envelope, mailer, or similar packaging of a type commonly used for the delivery of printed documents with designated data fields permitting entry of a return address of said sending computer and a receiving address of a receiving computer at respective locations on said envelope;
(b.2) providing means for selecting, from electronic files that are stored at said sending computer, files to be sent to said receiving computer;
(b.3) displaying a simulated packing list of files selected in step b.2; and
(b.4) providing means for effecting transmission via said network of a package comprising said return and receiving addresses and the selected files to said server.

23. A system for sending and receiving electronic files via a computer network comprising:
means for establishing a connection on said network between a sending computer and a server programmed to provide file transmission service;
at said sending computer:
means for displaying a simulated postal envelope, mailer, or similar packaging of a type commonly used for the delivery of printed documents with designated data fields permitting entry of a return address of said sending computer and a receiving address of a receiving computer at respective locations on said envelope;
means for selecting, from electronic files that are stored at said sending computer, selected files to be sent to said receiving computer;
means for displaying a simulated packing list of said selected files;
means for effecting transmission via said network of a package comprising said return and receiving addresses and the selected files to said server;
at said server, means responsive to receiving said package for transmitting a notification, via said network to the receiving computer at said receiving address, that said package is available for reception;
at said receiving computer, means for selectively retrieving said package via said network from said server.

24. The system of claim 23 further comprising:
means for establishing an account for said sending computer at said server, said account containing a balance of funds to be charged to said sending computer for packages transmitted by said sending computer via said server;
means for enabling said sending computer to selectively deposit funds in said account;
means for displaying at said simulated envelope charges to be assessed against said account for the transmission of said package to said receiving computer;
means responsive to receiving said package, prior to sending said notification to said receiving computer, for determining whether or not said account of said sending computer contains sufficient funds to cover the charges of transmitting said package;
means responsive to a determination that said account contains sufficient funds, for uploading said package and debiting said account of said sending computer by an amount corresponding to the charge for transmitting said package and transmitting said notification to said receiving computer;
means responsive to a determination that said account contains insufficient funds for notifying said sending computer that there are insufficient funds in said account.

25. The system of claim 23 further comprising:
means for establishing an account for said sending computer at said server, said account containing a balance of funds to be charged to said sending computer for packages transmitted by said sending computer via said server, means for enabling said sending computer to selectively deposit funds in said account; and
means for displaying at said simulated envelope actual charges to be assessed against said account for the transmission of said package to said receiving computer.

26. The system of claim 23 further comprising:
means for establishing an account for said sending computer at said server, said account containing a balance of funds to be charged to said sending computer for packages transmitted by said sending computer via said server;
at said sending computer, means for sending a predetermined amount of funds authorization for transmitting files via said server by a third computer, said means for sending comprising:
means for identifying said third computer and said predetermined amount of funds to said server;
at said server:
means for determining whether or not the third computer has an account at said server;
means responsive to a determination that an account exists for crediting said account with the predetermined amount of funds and transmitting notification of said crediting to said third computer; and
means responsive to a determination that an account does not exist for creating a new account for the third computer, crediting said new account with the predetermined amount of funds, and transmitting notification of said new account and crediting thereof to said third computer.

27. In a method for sending and receiving electronic files via a computer network, the step of displaying a simulated postal envelope at a sending computer, said envelope having a data field for entering the email address the sending computer at a location on the simulated envelope corresponding to the conventional return address location of a physical envelope, and a data field for entering the address of a receiving computer at a location on the simulated envelope corresponding to the recipient address location of a physical envelope.
